(19) United States
(12) Patent Application Publication
(10) Pub. No.: US 2006/0117877 A1
(43) Pub. Date: Jun. 8, 2006

(54) Feeding device and manufacturing method for rotation shaft

(76) Inventor: Yasuhira Inada, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/262,365

(22) Filed: Oct. 28, 2005

(30) Foreign Application Priority Data
Oct. 29, 2004 (JP) 2004-316967

(51) Int. Cl. F16H 21/02

(52) U.S. Cl. 74/27

(57) ABSTRACT

A feeding device includes a rotation shaft in which a male screw is formed on its outer peripheral face and a movable body which is provided with a plurality of projections that engage with the male screw. The male screw is constructed in a multiple thread screw comprising of a plurality of screws, and numbers of the projection(s) engaging with each of the plurality of screws are equal to each other. The multiple thread screw is preferably produced by using round form-rolling with a fixed side round form-rolling die and a movable side round form-rolling die.

### CROSS-REFERENCE TO RELATED APPLICATIONS

This application claims priority to Japanese application No. 2004-316967 filed Oct. 29, 2004, which is incorporated herein by reference.

### FIELD OF THE INVENTION

The present invention relates to a feeding device which linearly drives a movable body in an axial direction with rotation around the axial line of a rotation shaft and a manufacturing method for a rotation shaft which is used in the feeding device.

### BACKGROUND OF THE INVENTION

In an optical disk reproducing/recording device for performing reproducing or recording of information from or on an optical recording disk such as a CD, an optical head device, on which an objective lens and various optical elements are mounted, is moved in a radial direction of the optical recording disk by a feeding device. A stepping motor which is provided with a rotation output shaft whose outer peripheral face is formed with a male screw is used in the feeding device. A projection provided in an optical head device is engaged with the screw groove of the rotation output shaft to linearly drive the optical head device along the axial direction of the rotation output shaft.

In such a feeding device, the screw groove of the rotation output shaft is formed as a double threaded screw which is provided with a first screw 231 and a second screw 232 as shown in FIG. 3(a) by mechanical working such as rolling, cutting and grinding. Each of two projections 230 is engaged with one of screws 231, 232 (for example, the first screw 231) of a double threaded screw (see, for example, Japanese Patent Laid-Open No. Hei 8-340668).

Further, in another feeding device provided with a rotation output shaft on which a double threaded screw is formed, as shown in FIG. 3(b), four projections 230 are engaged with the first screw 231 of the double threaded screw and two projections 230 are engaged with the second screw 232 (see, for example, Japanese Patent Laid-Open No. Hei 6-98524).

In the feeding device constructed as described above, when feeding movement is performed frequently, the male screw of the rotation output shaft is worn so as to cause hindrance in the feeding movement. In order to solve the problem, the present inventor has examined the problem in various ways and found that, in the prior arts, only the first screw 231 is worn among the first screw 231 and the second screw 232 constructing the double threaded screw. In other words, in the former prior art, both of two projections 230 are engaged with only the first screw 231 and, in the latter prior art, four projections 230 are engaged with the first screw 231 and two projections 230 are engaged with the second screw 232. Therefore, wear is concentrated on the first screw 231 and thus the durability of the feeding device is decreased.

### OBJECTS AND SUMMARY OF THE INVENTION

The present inventor has paid attention to the situation where the male screw of the rotation shaft is formed in a multiple thread screw and proposes to prevent a specific portion of the male screw of the rotation shaft from concentratedly occurring wear. Therefore, in view of the problems described above, it is a first object and advantage of the present invention to provide a feeding device which is capable of improving durability by preventing unbalanced wear of the rotation shaft.

Further, it is a second object and advantage of the present invention to provide a manufacturing method for a rotation shaft which is suitable to prevent unbalanced wear of the rotation shaft.

In order to achieve the above objects and advantage, according to an embodiment of the present invention, there is provided a feeding device including a rotation shaft in which a male screw is formed on its outer peripheral face, and a movable body which is provided with a plurality of projections that engage with the male screw. The movable body is linearly driven in an axial direction by rotation of the rotation shaft, the male screw is constructed in a multiple thread screw comprising of a plurality of screws, and the numbers of the projection(s) engaging with each of the plurality of screws are equal to each other.

In the feeding device in accordance with an embodiment of the present invention, the male screw is constructed in a multiple thread screw comprising a plurality of screws, and the numbers of the projection(s) engaging with each of the plurality of screws are equal to each other. Therefore, wear occurs in each of the plurality of screws in a substantially same extent, and wear is not concentrated on a specific screw. Accordingly, the service life of a rotation shaft can be longer and thus durability of a feeding device can be improved.

In accordance with an embodiment of the present invention, the male screw is formed of a double threaded screw comprising a first screw and a second screw. In this case, the plurality of projections is provided with at least one of a first projection which engages with the first screw and at least one of a second projection which engages with the second screw, and the number of the first projection(s) and the number of the second projection(s) are equal to each other.

In accordance with an embodiment of the present invention, the number of the first projection(s) and the number of the second projection(s) are respectively one. In this case, it is preferable that, when “n” is an odd integer number of three or more, the first projection and the second projection are respectively engaged with the first screw and the second screw at positions away with the distance of “n” times of the pitch of the male screw in the axial direction. According to the construction described above, since the first projection and the second projection are engaged with the male screw at separated positions, a stable attitude of the movable body can be obtained.

The present invention may be effectively applied to a feeding device in which raw material of the rotation shaft is made of nonferrous metal such as copper alloy and aluminum. In other words, when the raw material is made of nonferrous metal such as copper alloy and aluminum, wear is easy to occur although screw working is easy, but the problem can be effectively prevented by utilizing the present invention.

In accordance with an embodiment of the present invention, the rotation shaft is, for example, the rotation output shaft of a motor.

According to an embodiment of the present invention, there is provided a manufacturing method for a rotation shaft which is used in a feeding device including preparing a shaft raw material for producing a rotation shaft, preparing a pair of rolled thread rolling dies comprising of a fixed side round form-rolling die and a movable side round form-rolling die, moving the movable side round form-rolling die in a direction of the fixed side round form-rolling die to clamp the shaft raw material, and relatively moving the shaft raw material in an axial direction with respect to the fixed side round form-rolling die and the movable side round form-rolling die while the fixed side round form-rolling die, the movable side round form-rolling die and the shaft raw material are respectively rotated to form a multiple thread screw. According to a manufacturing method for a rotation shaft in accordance with an embodiment of the present invention, a high degree of accuracy of a pitch between a plurality of screws constructing a multiple thread screw can be enhanced. Therefore, even when projections are engaged with a plurality of screws constructing a multiple thread screw, a stable feeding operation can be performed in a feeding device.

As described above, in the feeding device in accordance with an embodiment of the present invention, the male screw is constructed in a multiple thread screw comprising a plurality of screws, and the numbers of the projection(s) engaging with each of the plurality of screws are equal to each other. Therefore, wear occurs in each of the plurality of screws to substantially the same extent, and wear is not concentrated on a specific screw. Accordingly, the service life of a rotation shaft can be longer and thus durability of a feeding device can be improved.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1(a) is a schematic plan view showing an optical disk reproducing/recording device which is provided with a feeding device in accordance with an embodiment of the present invention and FIG. 1(b) is a side view showing a substantial portion of the feeding device;

FIGS. 2(a) and 2(b) are explanatory views respectively showing a feeding device in accordance with another embodiment of the present invention; and

FIGS. 3(a) and 3(b) are explanatory views showing conventional feeding devices.

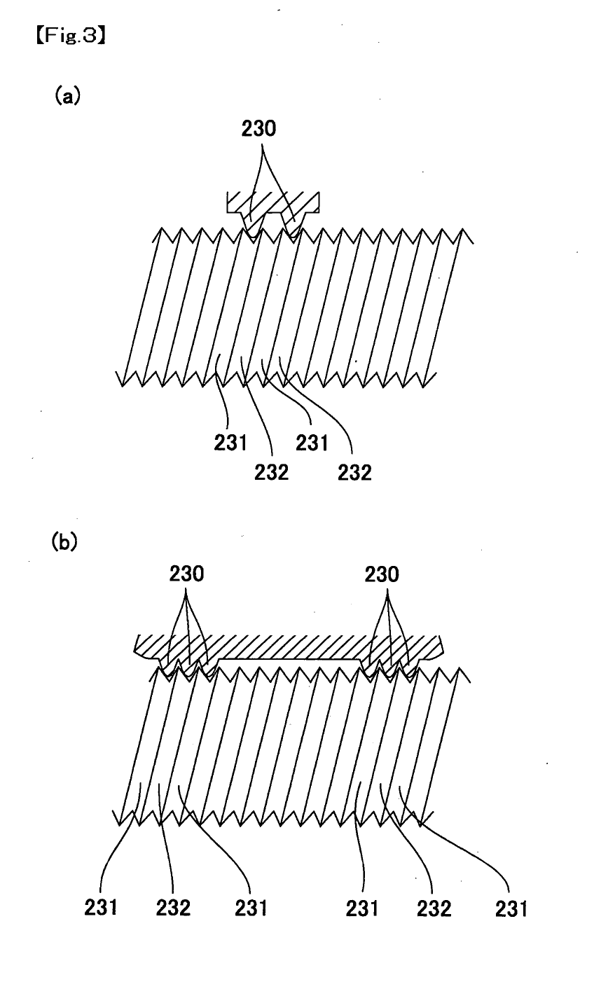

### DESCRIPTION OF THE PREFERRED EMBODIMENTS

Embodiments to which the present invention is applied will be described below with reference to the accompanying drawings.

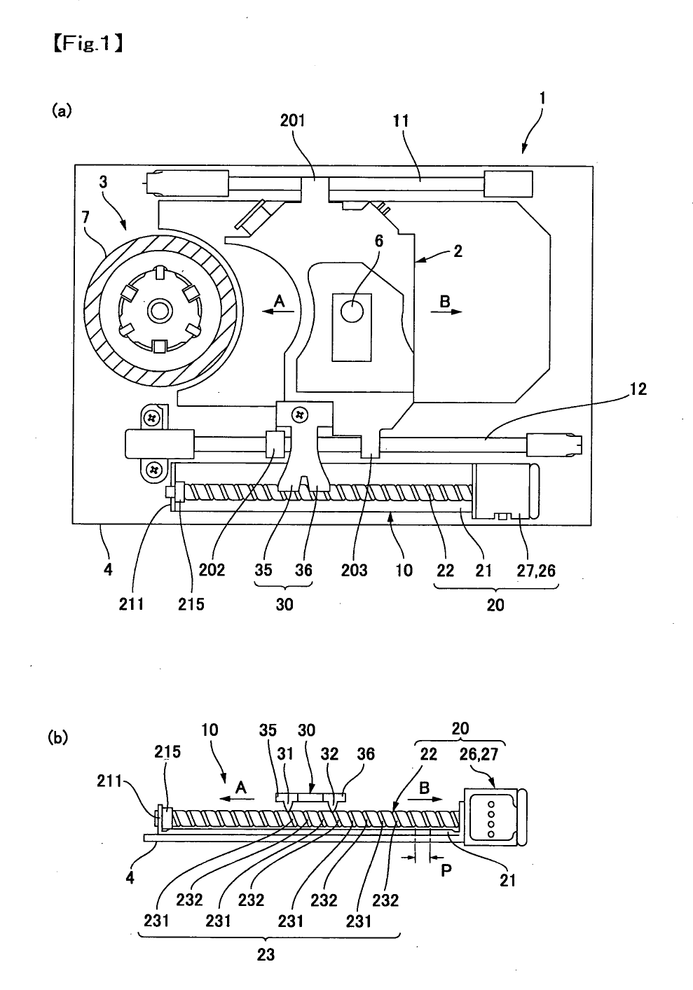

FIG. 1(a) is a schematic plan view showing an optical disk reproducing/recording device which is provided with a feeding device to which the present invention is applied and FIG. 1(b) is a side view showing a substantial portion of the feeding device.

An optical disk reproducing/recording device 1 shown in FIG. 1(a) is a device for performing reproduction or recording of information from or on an optical recording disk such as a CD or a DVD. The optical disk reproducing/recording device 1 includes an optical head device 2 (movable body) on which various optical elements such as an objective lens 6 are mounted, a feeding device 10 for moving the optical head device 2 in a radial direction of the optical recording disk, a disk drive device 3 provided with a spindle motor 7 to drive the optical recording disk, and a device frame 4 on which the feeding device 10 and the disk drive device 3 are mounted.

The feeding device 10 is provided with a first guide shaft 11 and a second guide shaft 12 which are extended in parallel toward the radial direction of the optical recording disk at positions on both sides of the optical head device 2. Both ends of these guide shafts 11, 12 are fixed on the device frame 4. Further, the optical head device 2 is provided with a bearing part 201 engaging with the first guide shaft 11 at its one end portion and a pair of bearing parts 202, 203 engaging with the second guide shaft 12 at its other end portion.

As shown in FIGS. 1(a) and 1(b), the feeding device 10 includes a PM type of stepping motor 20 whose rotation output shaft 22 is extended in parallel in the first guide shaft 11 and the second guide shaft 12. In this stepping motor 20, the base end side of the rotation output shaft 22 is connected to a motor main body 26 which is provided with a stator, a rotor magnet or the like in a motor case 27 for rotating the rotation output shaft 22 around the axial line. Further, in the stepping motor 20, a U-shaped frame 21 in cross section is fixed on the end face of the motor case 27 from which the rotation output shaft 22 is extended. The front end of the rotation output shaft 22 is rotatably supported by a bearing 215 which is fixed to a raising part 211 at the tip end portion of the frame 21.

In the feeding device 10 in an embodiment of the present invention, the rotation output shaft 22 of the stepping motor 20 is formed with a male screw 23 on the outer peripheral face of a shaft blank material which is made of nonferrous metal such as brass (copper alloy). The male screw 23 is formed as a double threaded screw having a first screw 231 and a second screw 232.

In the optical head device 2, a rack part 30 as a connecting portion to the rotation output shaft 22 is formed. The rack part 30 is formed of a resin plate such as a polyacetal resin plate and is provided with two branched tip end parts 35, 36. A first projection 31 and a second projection 32 which are fitted to the male screw 23 of the rotation output shaft 22 are formed in the two tip end parts 35, 36 by one piece each as shown in FIG. 1(b). The resin plate constructing the rack part 30 is elastically deformed in the state that the projections 31, 32 at the tip end parts of the rack part 30 are fitted to the male screw 23. Therefore, the rack part 30 is urged in a direction such that the projections 31, 32 at the tip end parts 35, 36 are pushed to the male screw 23 deeply. Accordingly, when electric power is supplied to the stepping motor 20 in the feeding device 10, the rotation output shaft 22 is rotated around the axial line and the rotating force is transmitted to the optical head device 2 through the male screw 23 and the rack part 30. As a result, the optical head device 2 moves back and forth in a linear manner toward the radial direction of an optical recording disk in the direction of the arrows “A” and “B” while it is guided by the first guide shaft 11 and the second guide shaft 12 (see FIGS. 1(a) and 1(b)). Lubricant such as grease is coated on the male screw 23 of the rotation output shaft 22 to reduce a frictional force between the male screw 23 and the projections 31, 32 of the rack part 30.

In the feeding device 10 constructed as described above in accordance with an embodiment of the present invention, the first projection 31 and the second projection 32 of the rack part 30 engage with the male screw 23 at positions separated by a distance of three times of the pitch “P” of the male screw 23. Therefore, the first projection 31 engages with the first screw 231 and the second projection 32 engages with the second screw 232. Accordingly, in both of two threaded screws 231, 232, each of the engaging portions with the projections 31, 32 is one position each and thus the number of engaging portion is equal.

Therefore, in the feeding device 10 in accordance with an embodiment of the present invention, even when feeding movement of the optical head device 2 is frequently performed, wear may occur in the two threaded screws 231, 232 to substantially the same degree and wear does not concentrate on a particular screw. Accordingly, since service life of the rotation output shaft 22 becomes longer, the durability of the feeding device 10 can be improved.

Further, the first projection 31 and the second projection 32 of the rack part 30 engage with the male screw 23 at the positions separated by a distance of three times of the pitch “P” of the male screw 23 in the axial direction and thus the distance of the engaging portions is long. Accordingly, the attitude of the optical head device 2 is stable all the time.

In the case where the rotation output shaft 22 is produced which is used in the feeding device 10 and the stepping motor 20 in accordance with an embodiment of the present invention, first, the male screw 23 is formed to shaft blank material made of copper alloy such as brass by working such as rolling, cutting and grinding (groove forming step). In this case, when the male screw 23 is formed by rolling, a high degree of mass-productivity can be obtained. In addition, round form-rolling is preferable to flat form-rolling as described below.

In a groove forming step by using round form-rolling (round form-rolling step), shaft blank material is disposed between a pair of rolled thread rolling dies, which is comprised of a fixed die and a movable die rotating in the same direction in a thread rolling machine. The movable die is moved in a direction to the fixed die to pinch the shaft blank material and, in this state, the shaft blank material is relatively moved in the axial direction with respect to the movable die and the fixed die while rotating the fixed dice, the movable dice and the shaft blank material. As a result, the outer peripheral face of the shaft blank material is plastically deformed by the fixed die and the movable die. In other words, the first screw 231 and the second screw 232 are simultaneously formed on the outer peripheral face and the rotation output shaft 22 is produced on which the male screw 23 provided with a double threaded screw is formed on its outer peripheral face.

According to the producing method described above, accuracy of the pitch “P” and the like between the first screw 231 and the second screw 232 constructing the double threaded screw can be enhanced. Therefore, even when the projections 31, 32 are respectively engaged with the first screw 231 and the second screw 232, a stable feeding operation can be attained in the feeding device 10.

Further, bending deformation of the rotation output shaft 22 in the round roll-forming in the rolling step is less than that in the flat roll-forming and the rotation output shaft 22 can be used without amending the bending deformation. On the other hand, flat rolling is suitable for production of a precise screw and it is effective that a screw with the pitch of, for example, 0.5 mm or less is formed by rolling. As a result, when round form-rolling is compared with flat roll-forming, round form-rolling is superior in the points of the bending of the rotation output shaft 22 and its working speed, and thus round form-rolling is especially effective in a producing method for the rotation output shaft 22 in the present invention.

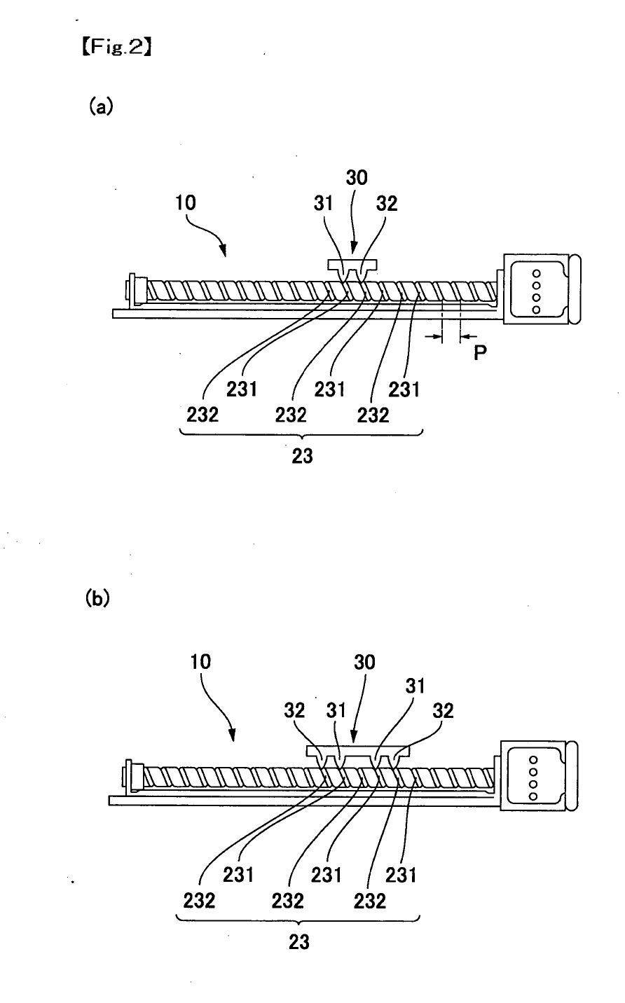

In an embodiment of the present invention, the first projection 31 and the second projection 32 of the rack part 30 engage with the male screw 23 at positions separated by a distance of three times of the pitch “P” of the male screw 23. However, as shown in FIG. 2(a), it may be constructed that the first projection 31 and the second projection 32 engage with the male screw 23 at positions separated by a distance of one time of the pitch “P” of the male screw 23. Even in the construction described above, wear occurs in the double threaded screw 231, 232 in nearly the same manner and wear is not concentrated on a specific thread.

In an embodiment of the present invention, when a high degree of accuracy is required in the attitude of the optical head device 2 like the feeding device 10 in the optical head device 2, it is preferable that the first projection 31 and the second projection 32 engage with the first screw groove 231 and the second screw groove 232 at positions separated by a distance of “n” times (“n”; an integer number of odd number of three or more) of the pitch “P” of the male screw 23 as the embodiment of the present invention described above.

Further, in the embodiment of the present invention described above, the first projection 31 and the second projection 32 are formed one by one in the rack part 30. However, as shown in FIG. 2(b), a plurality of the first projections 31 engaging with the first screw 231 and a plurality of the second projections 32 engaging with the second screw 232 may be respectively formed.

In addition, in an embodiment of the present invention, the raw material of the rotation output shaft is copper alloy such as brass. However, since wear is easy to occur when the raw material of the rotation output shaft is made of nonferrous metal such as aluminum, the application of the present invention is effective to extend the service life of the rotation output shaft 22.

In the embodiment described above, the rotation shaft is used as the rotation output shaft 22 of the stepping motor 20. However, the present invention may be applied to a feeding device 10 in which the rotational drive force of a motor is transmitted through a gear mechanism to a rotation shaft on which the male screw 23 is formed on its outer peripheral face. Further, in the embodiment described above, the projections formed in a resin plate are used as the rack part. However, the present invention may be applied to a feeding device in which a screw formed on a nut is used as the rack part.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A feeding device comprising:
a rotation shaft in which a male screw is formed on its outer peripheral face; and
a movable body being provided with a plurality of projections that engage with the male screw, the movable body being linearly driven in an axial direction by rotation of the rotation shaft;
said male screw being constructed in a multiple thread screw comprising of a plurality of screws, and numbers of the projection(s) engaging with each of the plurality of screws being equal to each other.

2. The feeding device according to claim 1, wherein the male screw is formed of a double threaded screw comprising a first screw and a second screw, and the plurality of projections comprise at least one of a first projection which engages with the first screw and at least one of a second projection which engages with the second screw, and the number of the first projection(s) and the number of the second projection(s) are equal to each other.

3. The feeding device according to claim 2, wherein the number of the first projection(s) and the number of the second projection(s) are respectively one.

4. The feeding device according to claim 3, wherein when “n” is three or more odd integer number, the first projection and the second projection are respectively engaged with the first screw and the second screw at positions away with the distance of “n” times of the pitch of the male screw in the axial direction.

5. The feeding device according to claim 1, wherein raw material of the rotation shaft is nonferrous metal.

6. The feeding device according to claim 1, wherein the rotation shaft is a rotation output shaft of a motor.

7. A manufacturing method for a rotation shaft which is used in a feeding device comprising the steps of:
preparing a shaft raw material for producing a rotation shaft;
preparing a pair of rolled thread rolling dies comprising a fixed side round form-rolling die and a movable side round form-rolling die;
moving the movable side round form-rolling die in a direction of the fixed side round form-rolling die to clamp the shaft raw material; and
relatively moving the shaft raw material in an axial direction with respect to the fixed side round form-rolling die and the movable side round form-rolling die while the fixed side round form-rolling die, the movable side round form-rolling die and the shaft raw material are respectively rotated to form a multiple thread screw.
